(19) United States
(12) Patent Application Publication
(10) Pub. No.: US 2014/0168054 A1
(43) Pub. Date: Jun. 19, 2014

(54) AUTOMATIC PAGE TURNING OF ELECTRONICALLY DISPLAYED CONTENT BASED ON CAPTURED EYE POSITION DATA

(71) Applicant: ECHOSTAR TECHNOLOGIES L.L.C., Englewood, CO (US)

(72) Inventors: Yunfeng Yang, Aurora, CO (US); Mi Chen, Aurora, CO (US)

(73) Assignee: ECHOSTAR TECHNOLOGIES L.L.C., Englewood, CO (US)

(21) Appl. No.: 13/714,514

(22) Filed: Dec. 14, 2012

(51) Int. Cl. G06F 3/01

(52) U.S. Cl. CPC G06F 3/013
USPC 345/156

(57) ABSTRACT

A method of controlling page turning operations for content displayed on a display element of an electronic device is presented here. The method begins by displaying a current page of content on the display element. The method continues by capturing eye position data that indicates position of an eye of a user of the electronic device, analyzing the captured eye position data to detect an eye-related condition corresponding to a page turning command, and executing the page turning command to display a new page of content.

### TECHNICAL FIELD

Embodiments of the subject matter described herein relate generally to the control of electronic devices. More particularly, embodiments of the subject matter relate to a methodology for automatically turning pages of electronically displayed content in response to detected eye position information.

### BACKGROUND

The prior art is replete with mobile devices and executable applications suitable for use with mobile devices. Indeed, the popularity of full-featured cellular telephones, tablet computers, and electronic book (e-book) devices has increased dramatically in recent times. A wide variety of downloadable computer-executable applications (often referred to as “apps”) has been developed for use with such mobile devices. For example, e-book applications can be purchased via the cellular telecommunication network for quick and easy downloading to cellular-based mobile devices.

An e-book device displays pages of text in a readable format that is designed to emulate pages of a physical book. When the reader reaches the end of the current page, the e-book device must be commanded to “turn the page” and display the next electronic page to the reader. Conventional e-book devices rely on physical buttons and/or touch screen gestures to initiate page forward and page back commands. For example, a swiping gesture may be utilized as a page turning command, or a “hot spot” on the touch screen may be pressed to enter a page turning command. Unfortunately, these techniques require manual interaction with the device. In certain situations, it may be inconvenient or impossible for the reader to manually engage the device.

### BRIEF SUMMARY

A method of controlling page turning operations for content displayed on a display element of an electronic device is presented here. The displays a current page of content on the display element, and captures eye position data that indicates position of an eye of a user of the electronic device. The method continues by analyzing the captured eye position data to detect an eye-related condition corresponding to a page turning command, and by executing the page turning command to display a new page of content.

An electronic device is also presented here. The device includes a processing architecture having at least one processor, a display element operatively coupled to and controlled by the processing architecture, and a non-transitory computer readable medium operatively associated with the processing architecture. The computer readable medium has executable instructions that, when executed by the processing architecture, cause the processing architecture to perform a method that begins by displaying a current page of readable text on the display element. The method continues by capturing eye position data that indicates movement of an eye of a user of the electronic device, analyzing the captured eye position data to detect an eye-related condition corresponding to a page turning command, and executing the page turning command in response to detecting the eye-related condition.

A method of operating an electronic device having a display element is also provided. The method involves: determining a physical orientation of the electronic device; obtaining a distance between the electronic device and an eye of a user of the electronic device; displaying a current page of content on the display element; capturing images of the eye of the user during a time when the current page of content is displayed on the display element; and analyzing the images to obtain eye position data. The eye position data correlates position of the eye of the user with areas of the display element. The method continues by detecting an eye-related condition corresponding to a page turning command, based on the determined physical orientation of the electronic device, the obtained distance between the electronic device and the eye of the user, and the obtained eye position data.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a front view of an electronic device displaying a page of text content;

FIG. 2 is a schematic representation of an embodiment of an electronic device that supports the features and functions described herein;

FIG. 3 is a diagram that illustrates typical user eye positions corresponding to different focus areas of a display element;

FIG. 4 is a diagram that illustrates different control zones of a display element;

FIG. 5 is a flow chart that illustrates an embodiment of a device initialization process;

FIG. 6 is a flow chart that illustrates an embodiment of a training process;

FIG. 7 is a flow chart that illustrates an embodiment of a page turning process; and

FIG. 8 is a flow chart that illustrates an embodiment of a page turn decision process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or processor-executed. In practice, one or more processor devices can carry out the described operations, tasks, and functions by manipulating electrical signals representing data bits at memory locations in the system memory, as well as other processing of signals. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in any processor-readable non-transitory medium or tangible element. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like. A software-based application or program may be preloaded in an electronic device, installed from a media product, or downloaded to the device via computer networks such as the Internet, an intranet, a LAN, or the like.

According to various embodiments, an electronic device is suitably configured to perform e-book functions (the electronic device may actually be an e-book device, or it may be another type of device having the necessary functionality to support e-book features). The electronic device utilizes certain onboard components and processing logic to automatically “turn the pages” of a displayed e-book when certain conditions are detected. More specifically, the electronic device monitors the reader's eye position and/or eye movement to determine whether or not the user intends to turn the page forward or backward and, in response to such a determination, displays a new page on the display element. Related calibration and user training methodologies are also presented herein.

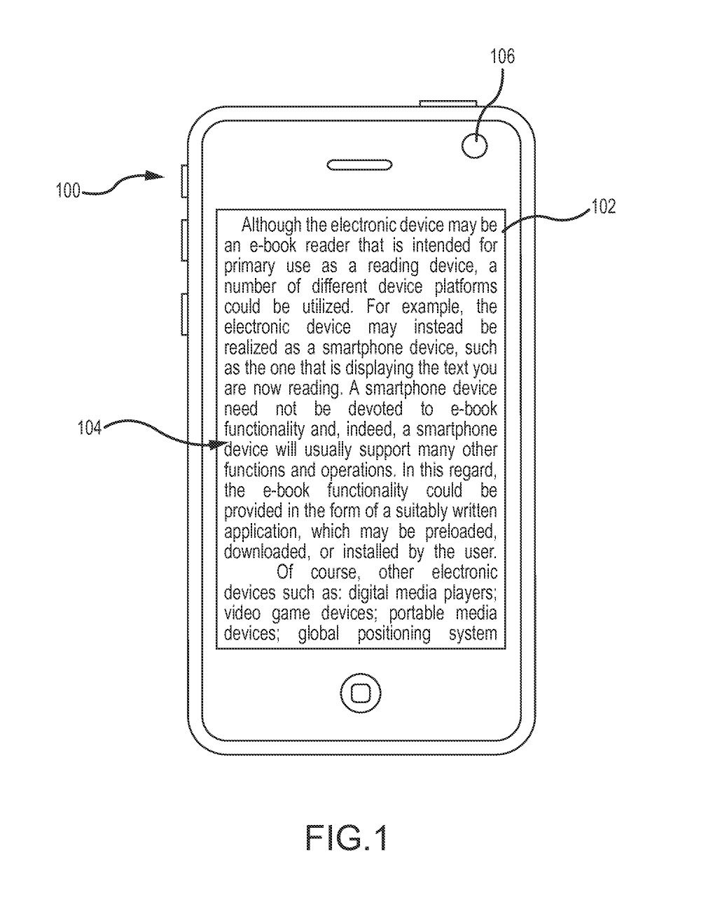

Turning now to the figures and with initial reference to FIG. 1, a front view of an exemplary embodiment of an electronic device 100 is depicted. The illustrated embodiment of the electronic device 100 is implemented as a mobile device, e.g., a smartphone. It should be appreciated that the electronic device 100 may be configured in any number of alternative ways, using a variety of different hardware platforms. In this regard, embodiments of the electronic device 100 may be implemented as any of the following, without limitation: an e-book device; a computer device (including desktop, laptop, tablet, handheld, netbook, and other form factors); a digital media player; a video game system; a portable medical device; an electronic navigation system; a global positioning system (GPS) device; a personal digital assistant; electronic toys or games; or any electronic or processor based device having a display element.

The electronic device 100 includes at least one display element 102 associated therewith. The display element 102 may be integrated with the main housing or body of the electronic device 100 (as shown in FIG. 1), or it may be physically or wirelessly coupled to the electronic device 100 in any suitable manner. The display element 102 is suitably configured and controlled to display graphical content generated by the electronic device 100. More specifically, the display element 102 can display pages of content to the user of the electronic device 100. The displayed content may be anything that can be divided, segmented, or otherwise separated into pages. For example, the content may be, without limitation: web pages; word processor documents; spreadsheet documents; image content; a graphical user interface; or the like. In certain embodiments, the content represents e-book content, wherein each displayed page may be considered to be a page of an e-book. Accordingly, FIG. 1 shows a current page of text content 104 displayed on the display element 102.

The electronic device 100 also includes a user-facing camera 106 integrated therein. The camera 106 is suitably configured to capture images using the native image capturing capabilities of the electronic device 100. The pixel resolution, image capture rate, and other operating specifications of the camera 106 may vary from one implementation of the electronic device 100 to another.

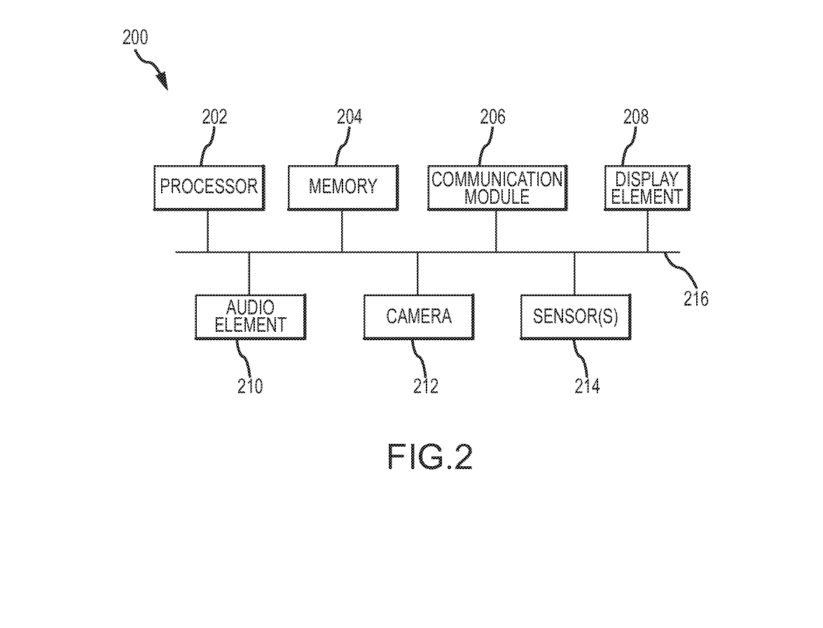

FIG. 2 is a schematic representation of an embodiment of an electronic device 200 that supports the features and functions described herein. In this regard, the electronic device 100 shown in FIG. 1 could be implemented in accordance with the electronic device 200 shown in FIG. 2. In some embodiments, the electronic device 200 includes or cooperates with: at least one processor 202; a suitable amount of memory 204; a communication module 206; at least one display element 208; at least one audio element 210; at least one camera 212; and at least one sensor 214. An implementation of the electronic device 200 may include additional functional elements and components that are suitably configured to support traditional or well-known features, which will not be described in detail here. The elements of the electronic device 200 may be coupled together via a bus or any suitable interconnection architecture 216.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. The processor 202 may be realized as a microprocessor, a controller, a microcontroller, or a state machine. Moreover, the processor 202 may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor 202 to enable the processor 202 to read information from, and write information to, the memory 204. In the alternative, the memory 204 may be integral to the processor 202. As an example, the processor 202 and the memory 204 may reside in an ASIC. The memory 204 may be employed to save and maintain certain device-specific application programs and software that is designed to support the desired functionality of the electronic device 200. For example, the memory 204 may be realized as a non-transitory computer readable medium that is operatively associated with the processor 202, wherein the computer readable medium includes executable instructions that, when executed by the processor 202, cause the processor 202 to perform the techniques and methodologies described in more detail below. As mentioned above, the software instructions may represent one or more e-book applications that reside at the electronic device 200.

The communication module 206 enables the electronic device 200 to communicate with one or more other devices, systems, or components as needed. In practice, the communication module 206 could support wireless data communication and/or data communication over physical links, as appropriate to the particular embodiment. In this regard, the communication module 206 could support wired data communication using an Ethernet connection, using a universal serial bus (USB) connection, or the like. The communication module 206 may also be designed to support one or more wireless data communication protocols, including, without limitation: RF; IrDA (infrared); Bluetooth; ZigBee (and other variants of the IEEE 802.15 protocol); IEEE 802.11 (any variation); IEEE 802.16 (WiMAX or any other variation); cellular/wireless/cordless telecommunication protocols; wireless home network communication protocols; satellite data communication protocols; and proprietary wireless data communication protocols such as variants of Wireless USB.

The display element 208, which may be incorporated into the front panel of the electronic device 200, represents the primary graphical interface of the electronic device 200. In practice, the display element 208 may be operatively coupled to and controlled by the processor 202. The display element 208 may leverage known LCD, LED, electronic ink (electronic paper), OLED, IMOD, AMOLED, plasma, TFT, and/or other display technologies, without limitation. Of course, the actual size, resolution, and operating specifications of the display element 208 can be selected to suit the needs of the particular application and in accordance with the form factor and platform of the electronic device 200. Notably, the display element 208 may be suitably configured as a touch screen that leverages known touch screen techniques and technologies such as “pinching,” “grabbing,” “zooming,” “swiping,” and “rotating.” As described in more detail herein, the display element 208 can be used to display pages of content to a user, and the pages of content can be automatically turned using certain eye position detection and/or eye movement monitoring techniques.

The audio element 210 may be realized as a speaker or other audio transducer that can be driven and controlled by the electronic device 200 as needed. The audio element 210 may be used to generate sounds, alerts, and messages for the user. The audio element 210 could also be used to provide audio content associated with displayed content if so desired.

In many embodiments, the camera 212 is integrated with the electronic device 200. In alternative embodiments, the camera 212 could be a peripheral component that is coupled to (or otherwise communicates with) the electronic device 200. For example, the camera 106 shown in FIG. 1 represents a user-facing camera that is integrated into the housing of the host electronic device 100. In a laptop or tablet computer implementation, an integrated webcam can be used for the camera 212. In a desktop computer application, a peripheral webcam mounted atop (or integrated into) a monitor display could be used for the camera 212.

The camera 212 is configured to capture images of the user, wherein the images are processed to support the automatic page turning methodology described here. The operating and technical specifications of the camera 212 will vary from one embodiment of the electronic device 200 to another, depending upon the hardware platform, native feature set, and intended application. For example, some or all of the following items may be device-specific: the pixel resolution, the quality and characteristics of the image sensor(s), the number of image sensors, the lens type, the number and type of filters, the aspect ratio, and zooming capability. Accordingly, the image-dependent features and functions described in more detail herein may be influenced by the particular characteristics and operating specifications of the camera 212.

In some embodiments, the electronic device 200 includes or cooperates with one or more sensors 214 that collect respective sensor data, which in turn may influence the automatic page turning function described herein. A given sensor may include, cooperate with, or be realized as any of the following sensor types, without limitation: a motion detector; a microphone; a physiological characteristic sensor; a thermometer; a light intensity meter; a white balance meter; an accelerometer; a gyroscope (gyro); or a distance meter. It should be appreciated that other sensor types and configurations could be employed if so desired. In practice, any given sensor could be implemented as an integral component of the electronic device 200. Moreover, a sensor 214 may cooperate with other components of the electronic device 200. For example, a light intensity meter or a white balance meter may rely on information obtained by the camera 212.

Certain embodiments utilize a light meter or sensor to collect light status information. The light status information may be associated with environmental lighting conditions near or surrounding the electronic device 200. In practice, the detected light information may be related to natural and/or artificial light sources, light that reaches the device in a direct path, light that is reflected or diffused, etc. Moreover, the detected light information may be influenced or affected by the presence of objects (including the user) near the device. Thus, a light intensity meter could be used to measure the amount of outside light, the amount of indoor light, and/or the amount of ambient light near the electronic device 200 at any given time. Alternatively (or additionally), the electronic device 200 could obtain and process user-entered light status information, settings, or selections.

Some embodiments also utilize an accelerometer and/or a gyro to collect device orientation information associated with the physical orientation of the electronic device 200. Accordingly, these sensors 214 can be used to determine the orientation of the electronic device 200 relative to a reference coordinate system. In practice, these sensors 214 provide data that can be processed by the electronic device 200 to determine whether the user is holding the electronic device 200 upright, upside down, sideways, or the like. These sensors 214 could also be utilized to determine whether the user is walking, standing, traveling on a train, or the like. As explained in more detail below, the sensors 214 may collect information and data that influences the manner in which the automatic page turning feature operates.

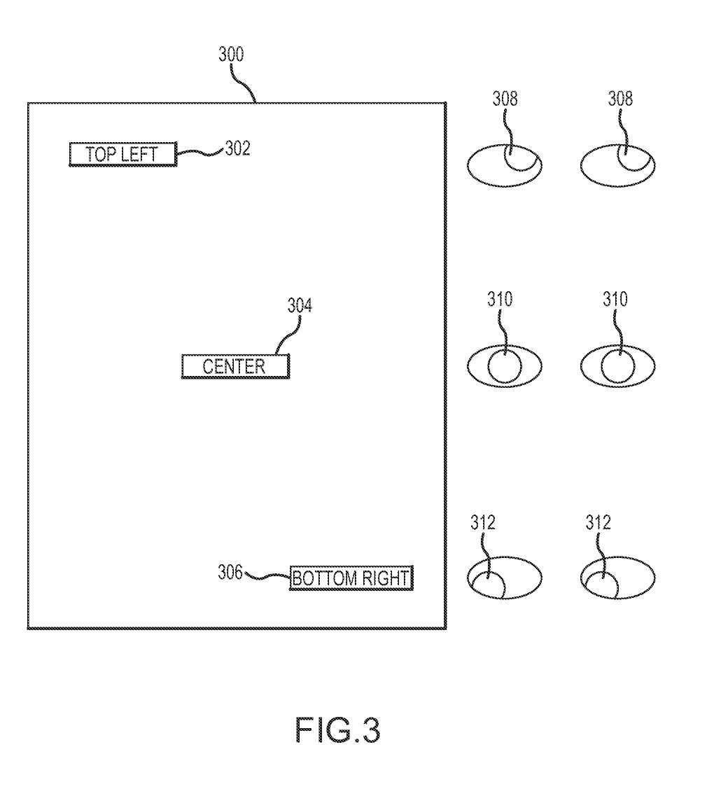

As mentioned above, embodiments of the electronic devices 100, 200 support an automatic page turning feature that relies on the detection and processing of eye position data. In this regard, FIG. 3 is a diagram that illustrates typical user eye positions corresponding to different focus areas of a display element 300 of an electronic device. Although not always required, the display element 300 is depicted in a traditional rectangular shape in the normal portrait orientation. It should be appreciated that the concepts presented here may also be extended to display elements having non-rectangular shapes and to the display element 300 when utilized in the landscape orientation.

FIG. 3 depicts three areas of the display element 300: a top left area 302; a center area 304; and a bottom right area 306. FIG. 3 also shows how a reader's eyes might appear when the reader is focusing at or near the three areas of the display element 300. FIG. 3 shows the display element 300 and the three areas as they would be viewed from the reader's perspective. The diagrams of the reader's eyes, however, are depicted from the perspective of a third person looking at the reader's face. When the reader is focused on the top left area 302, the eyes may appear as depicted near the top of FIG. 3. More specifically, the reader's irises 308 (and pupils) are located upward and to one side relative to the overall shape of the eyes. In contrast, when the reader is viewing the center area 304, the reader's irises 310 (and pupils) are centrally located relative to the overall shape of the eyes. When the reader is looking at or near the bottom right area 306, the reader's irises 312 (and pupils) are located downward and to the other side. It should be appreciated that the reader's irises and pupils may assume any position as the reader's focus traverses across and down a page of content that is rendered on the display element 300. In a typical scenario, the reader's eyes will move from the left to the right (corresponding to the reading of one line), then quickly from the right to the left (corresponding to the transition from the end of one line to the beginning of another line), and so on. Moreover, the reader's eyes will move downward with each completed line, from near the top of the page to near the bottom of the page. The bottom right area 306 will usually represent the end of the currently displayed page.

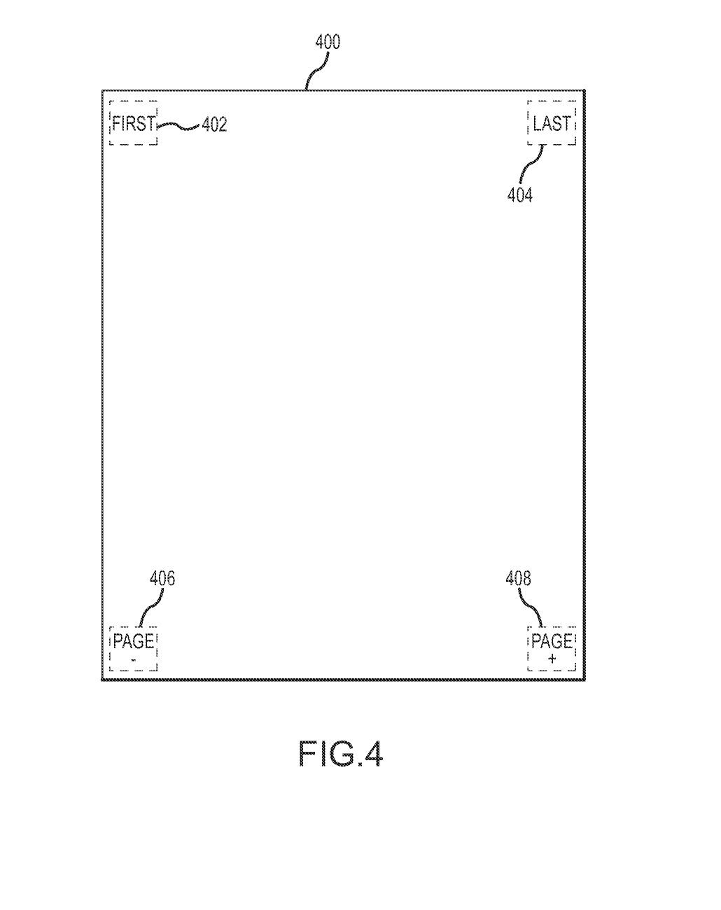

The automatic page turning methodology described herein detects the position and/or movement of the reader's eyes while a page of content is displayed, and processes the eye position information to determine whether or not to automatically turn the page. Some embodiments utilize one or more control zones to initiate page turning operations. In this regard, FIG. 4 is a diagram that illustrates different control zones of a display element 400. For simplicity and clarity, the display element 400 is shown without any displayed text or other graphical content.

Although any number of control zones (including only one) may be supported by an embodiment of an electronic device, the display element 400 is shown with four distinct and separate control zones. In particular, the display element 400 includes a “First Page” control zone 402, a “Last Page” control zone 404, a “Page Back” control zone 406, and a “Page Forward” control zone 408. The shapes, sizes, locations, and/or other graphical or operational characteristics of the various control zones (relative to the area defined by the display element 400) may be different from one device to another, from one embodiment to another, etc. Moreover, the graphical and/or operational characteristics of the control zones may vary from one user of a device to another, and the characteristics could be subject to user preference settings in some embodiments.

Although not always required, the “First Page” control zone 402 is located at or near the top left corner of the display element 400, the “Last Page” control zone 404 is located at or near the top right corner of the display element 400, the “Page Back” control zone 406 is located at or near the bottom left corner of the display element 400, and the “Page Forward” control zone 408 is located at or near the bottom right corner of the display element 400. Notably, the “Page Forward” control zone 408 is positioned at or near a region that typically corresponds to the end of a page of content, especially when the content is a written page of text, a page of an e-book, or a text-based web page. Accordingly, the “Page Forward” control zone 408 is located at or near a focal point that corresponds to the end of a written page.

A control zone may be predefined or predetermined, or it could be dynamically generated if so desired. Moreover, the location, size, and/or boundary of a control zone could be designated or arranged by the user, by the device manufacturer, or the like. In certain embodiments, a control zone could be flexibly defined or otherwise influenced by the content being displayed (e.g., influenced by the particular font used, by the font size, and/or by the arrangement of content on the currently displayed page). For example, if the currently displayed has only a small amount of content such that there is a large patch of empty space, then the “Page Forward” control zone could be relatively large or located after the end of the last displayed words.

As described in more detail herein, the electronic device defines each control zone in a suitable manner that makes it easy to detect when the reader's eyes are directed at one of the control zones. In other words, the electronic device utilizes certain image recognition, image processing, and sensor data processing techniques to detect when the reader is viewing text that is located at or near one of the control zones. The electronic device may take specified actions when the reader is looking at one of the control zones. In some embodiments, other criteria (in addition to the detection of a specific eye position) may need to be satisfied before the electronic device initiates a page turning action.

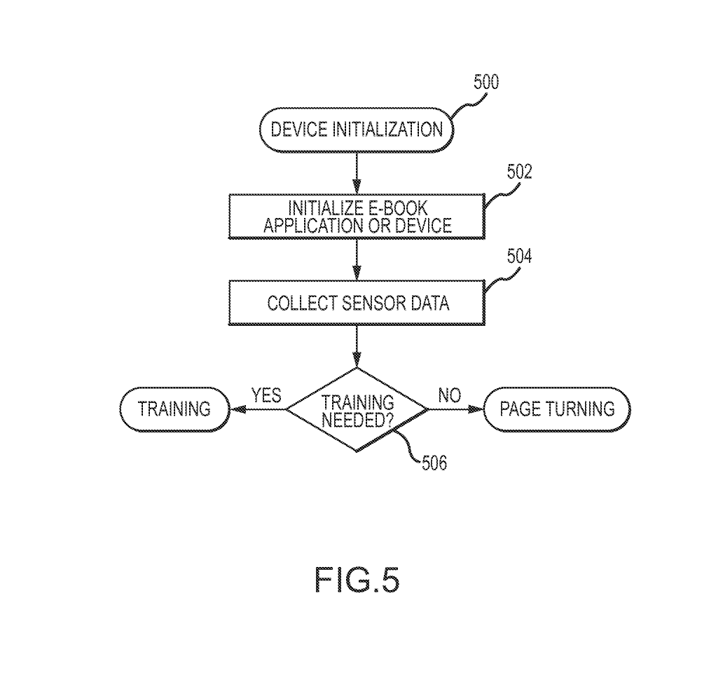

A number of exemplary operating processes will now be described with reference to FIGS. 5-8. The various tasks performed in connection with an illustrated process may be performed by software, hardware, firmware, or any combination thereof. For illustrative purposes, the following description of the processes may refer to elements mentioned above in connection with FIGS. 1-4. In practice, portions of a described process may be performed by different elements of the described electronic device, e.g., a camera, an accelerometer, a display element, or the like. Moreover, at least some of the described tasks could be performed in a distributed manner in some embodiments. For example, a server-based system could cooperate with the electronic device to support the methodology described here. It should be appreciated that a described process may include any number of additional or alternative tasks, the tasks shown in the figures need not be performed in the illustrated order, and that a described process may be incorporated into a more comprehensive procedure or process having additional functionality not addressed in detail herein. Moreover, one or more of the tasks shown in a figure could be omitted from an embodiment of the associated process as long as the intended overall functionality remains intact.

FIG. 5 is a flow chart that illustrates an embodiment of a device initialization process 500, which may be performed by an electronic device of the type described above. The process 500 assumes that the host electronic device already has an appropriate e-book application installed or loaded therein, or that the electronic device supports a cloud-based e-book application that can display pages of content. The process 500 may begin in response to a power-on command for the device or in response to the user launching the e-book application. In this regard, the process 500 initializes the e-book application or the electronic device itself (task 502). Task 502 may cause the e-book application to launch or become active, and it may also initialize the onboard camera and one or more other onboard sensors of the electronic device.

The process 500 may continue by collecting and processing sensor data (task 504). Task 504 is performed to determine whether or not training is needed (query task 506) for purposes of the automatic page turning feature. If training is needed (the “Yes” branch of query task 506), then the process 500 may initiate a training process. If training is not required at this time (the “No” branch of query task 506), then the process may exit, continue as needed with the e-book functionality, lead to a page turning process, or the like.

Referring again to task 504, the electronic device may utilize a camera, an accelerometer, a gyro, a light meter or sensor, a wireless transceiver, and/or other sensors, transducers, or detectors to collect the desired type and amount of sensor data. In some embodiments, task 504 collects light status information that is associated with the environmental lighting conditions near the electronic device. The light status information could be collected or detected by the onboard camera and/or a devoted light sensor. The light status information may include, without limitation: light intensity information; white balance information; spectral information; camera sensitivity information (e.g., ISO data); camera exposure settings; camera aperture settings; and the like. Task 504 may also collect device orientation information that is associated with the current physical orientation of the electronic device relative to a reference coordinate system). The device orientation information could be collected or detected by an onboard accelerometer, an onboard gyroscope element, a gravity meter, an inclinometer, a compass, or the like. The device orientation information can be processed to determine the orientation of the electronic device at any given moment and/or over time. For example, the device orientation information could be used to determine whether the electronic device is upright, flipped over, in a horizontal plane, in a vertical plane, sideways, etc. In some embodiments, task 504 collects distance information that is associated with a distance between the eye (or face) of the user and the electronic device. The distance information could be collected or detected using a camera, an infrared emitter, an audio transducer, a microphone, a wireless communication module with a received signal strength meter, or the like. For example, the process 500 may capture an image of the user's face and then estimate the distance to the user based on the shape, size, or other characteristics of the user's face. More specifically, the process 500 could analyze the image, calculate the size of the user's eyes in the image, and estimate the distance based on the size of the eyes. Alternatively (or additionally), the electronic device could obtain user-provided distance measurements or user-selected distance values.

The process 500 considers at least some of the collected sensor data to determine whether or not training is needed (query task 506) to calibrate the electronic device for correlation of captured eye position data with certain areas of the display element (as explained above with reference to FIG. 4). To this end, if the collected sensor data indicates operating conditions for which the electronic device has not been calibrated, then query task 506 initiates the training process. For example, the collected sensor data may indicate that the electronic device is being held about twelve inches away from the reader's face, with the screen tilted at an angle of about ten degrees, and in a bright outdoor setting. If the process 500 finds no calibration data for this set of conditions (or very old or stale calibration data for this set of conditions), then the “Yes” branch of query task 506 is followed. In some embodiments, therefore, the process 500 could be repeated for any number of different possible scenarios such that the automatic page turning procedure is accurately calibrated to account for a variety of different operating conditions and reading situations. Moreover, training could be performed on a user-by-user basis if so desired. This could be accomplished by considering a user identifier (e.g., user login credentials), using facial recognition software, or the like.

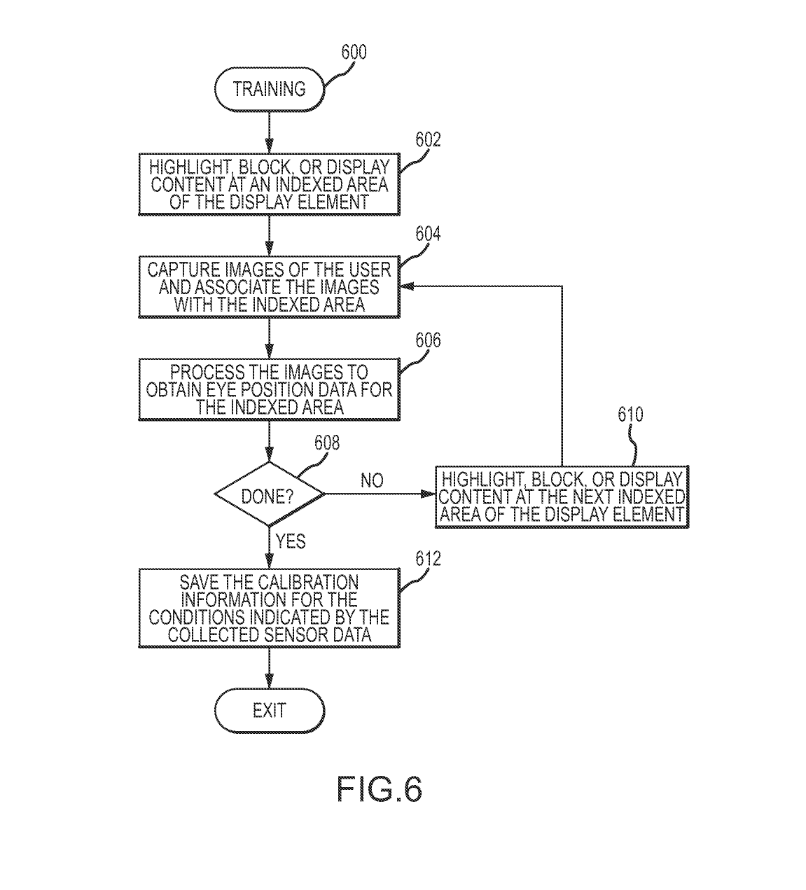

FIG. 6 is a flow chart that illustrates an embodiment of a training process 600, which may be performed in response to the “Yes” branch of query task 506 (see FIG. 5). The process 600 captures images of the reader's eyes (for the currently detected operating state and conditions), associates certain eye positions with areas of the display element, and records the eye position relationships for use in the automatic page turning process. Accordingly, the process 600 represents one exemplary embodiment of a training procedure that calibrates the electronic device for correlation of captured eye position data with certain areas of the display element.

Various embodiments of the process 600 may begin by highlighting, blocking, or otherwise displaying graphical content or information at a designated and indexed area of the display element (task 602). In practice, task 602 may simply display one or more words or a phrase at a predetermined location of the screen, wherein the user is instructed to read those words, focus on the location, or look at the block of text. The number of words displayed and the shape/size of the focus region may be selected to optimize the training procedure, and may be selected in accordance with the operating specifications of the camera and display element (e.g., image pixel size, display resolution, display size, and the like). In some embodiments, task 602 could be associated with the display of a colored spot or region on the display element, the generation of a flashing “light” or icon at the desired area of the display element, or the like. In other words, task 602 need not render readable text to accomplish the desired device training.

For simplicity, this example assumes that task 602 generates and displays one word on the display element at a time. The process 600 assumes that the user is looking at the displayed word. Accordingly, the process 600 captures one or more images of the user (task 604) and associates the captured images with the indexed area or position of the displayed word. In some embodiments, task 604 captures a plurality of images for each training position for the sake of averaging or other statistical processing. The process 600 may continue by processing the captured images to obtain eye position data for the indexed area (task 606). For example, task 606 could perform image processing to identify the location of the user's irises and/or the location of the user's pupils in each captured image. In some embodiments, task 606 processes multiple images captured for the same training position and generates the eye position data based on the information conveyed in the multiple images. It should be appreciated that task 606 could be performed by the electronic device and/or by another device or system that communicates with the electronic device. As a result of task 606, the process 600 may obtain left and right eye position data that corresponds to the particular display location of the training word.

The process 600 may continue as needed to obtain eye position data for any number of different locations of the display element. In this regard, the process 600 may check whether or not any other locations need to be considered (query task 608). If the training is not finished (the “No” branch of query task 608), then the process 600 continues by highlighting, blocking, or displaying content at the next indexed area of the display element (task 610). For this particular example, task 610 results in the display of a word at a location that is different than the previous training location. As depicted in FIG. 6, task 610 may lead back to task 604 such that the eye position data is obtained for the next indexed location of the display element. In some embodiments, the process 600 scans the display element in a manner that emulates the natural and ordinary reading pattern, e.g., from left to right across the page, and from the top to the bottom of the page. Of course, the process 600 could display the training words in any order, in any pattern (random or otherwise), and in accordance with any desired scheme.

The process 600 performs image capturing and processing for the desired number of training locations. It should be appreciated that the number of training locations, the number of images taken at each training location, and the speed of the overall training procedure may be regulated as needed to contemplate the operating specifications of the electronic device and/or to accommodate the current operating conditions as detected by the electronic device. When query task 608 determines that all of the eye position data has been acquired, the process 600 may save the calibration information for the conditions indicated by the collected sensor data (task 612). Thus, the electronic device can access and use the saved calibration information whenever the same (or approximately the same) conditions are detected again in the future.

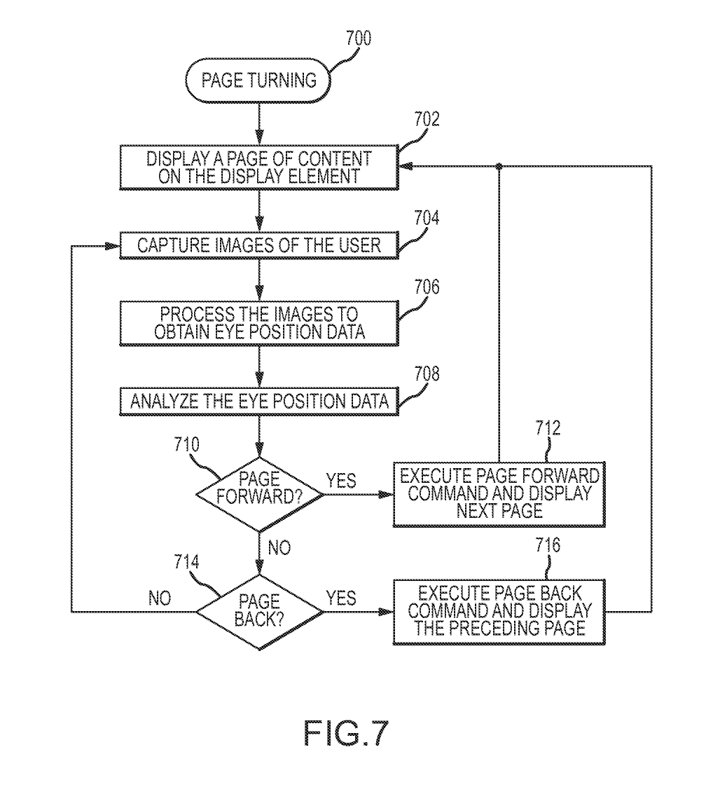

FIG. 7 is a flow chart that illustrates an embodiment of a page turning process 700, which may be performed in response to the “No” branch of query task 506 (see FIG. 5). Thus, the process 700 assumes that the electronic device has already been trained and calibrated to some extent. More particularly, the process 700 assumes that the electronic device has been calibrated for purposes of the currently detected set of operating conditions. The process 700 represents one exemplary embodiment of a method of controlling page turning operations for content displayed on a display element of a suitably configured electronic device.

Although not depicted in FIG. 7, some embodiments may begin by determining the physical orientation of the electronic device, obtaining the distance between the electronic device and at least one eye (or the face) of the reader, and/or collecting light status information that indicates environmental lighting conditions near the electronic device. This information and/or other sensor data can be collected in an ongoing manner to ensure that the page turning process 700 remains calibrated for the current operating conditions. The collection and processing of this information was described above with reference to the process 500 (see FIG. 5).

The electronic device displays a current page of content, such as readable text, on the display element (task 702). This example assumes that e-book content is displayed one page at a time and that the user does not scroll the content on the page. Accordingly, the displayed page remains stationary on the display element until the electronic device is commanded to turn the page. The process 700 captures or otherwise obtains images of the user during a time when the current page of content is displayed on the display element (task 704). Depending upon the current operating conditions and the specifications of the electronic device, the field of view and content of each captured image may include the user's head, the user's face, one or both of the user's eyes, etc. Task 704 may capture digital image data at any desired frequency that is suitable for the given embodiment. For example, it may be desirable to obtain one image every 10 milliseconds, or one image every 500 milliseconds. In certain implementations, the image capturing is performed at a variable frequency such that more images are taken under some conditions, and less images are taken under other conditions. For example, image capturing and processing may be less important when the user is reading text near the middle of the page, and more important when the user is approaching the end of the page.

The process 700 may continue by processing the captured images in an appropriate manner to extract or obtain the relevant eye position data (task 706). It should be appreciated that task 706 could be performed by the electronic device and/or by another device or system that communicates with the electronic device. As mentioned above, the eye position data correlates the current position of the reader's eye (pupil or iris location) with certain predetermined areas of the display element, preferably in accordance with the calibration data. Thus, task 706 may perform image processing, shape recognition, and/or facial recognition to identify and isolate the eyes in each captured image. Task 706 may also be performed to link or otherwise associate the eye position information in each captured image to a corresponding location, area, or region of the displayed page of content. This may be accomplished by geometric calculations that consider the known shape and size of the display element, the detected distance between the electronic device and the user, the calibration information, and the like.

The captured eye position data can be analyzed in an ongoing manner (task 708) to detect an eye-related condition or state that corresponds to a page turning command to be executed by the electronic device. It should be appreciated that task 708 could be performed by the electronic device and/or by another device or system that communicates with the electronic device. A page turning command may be, without limitation: a page forward command to turn one or more pages ahead; a page back command to turn one or more pages back; a first page command to display the first page of content; a last page command to display the last page of content; or a bookmark command to display a bookmarked or save page. Of course, other types and modes of page turning commands could also be supported. In some embodiments, the eye position data is captured and analyzed in an ongoing manner to monitor and track the position or movement of one or both eyes as the user reads the currently displayed page of the displayed content.

As mentioned previously, the manner in which the electronic device resolves the reader's eye position is influenced by at least some of the conditions and factors that are used to calibrate the page turning feature for the given operating state. Thus, at least some portions of the process will be influenced or determined by the collected light status information, the collected or calculated device orientation information, the distance information (that indicates the distance between the device and the user's eyes), and/or possibly other sensor data.

This example assumes that the process 700 checks for at least two types of page turning commands: a “Page Forward” command; and a “Page Back” command. If the process detects an eye-related condition that corresponds to a “Page Forward” command (the “Yes” branch of query task 710), then the electronic device initiates and executes the “Page Forward” command (task 712) to display a new page of content, e.g., the next page in sequence that follows the current page. After displaying the new page, the process 700 may lead back to task 702, and continue as previously described. If the process detects an eye-related condition that corresponds to a “Page Back” command (the “Yes” branch of query task 714), then the electronic device initiates and executes the “Page Back” command (task 716) to display a new page of content, e.g., the page preceding the current page of content. After displaying the new page, the process 700 may lead back to task 702, and continue as previously described. Thus, the process 700 can continue as the user reads through an e-book such that the user need not physically manipulate the electronic device at the end of each page.

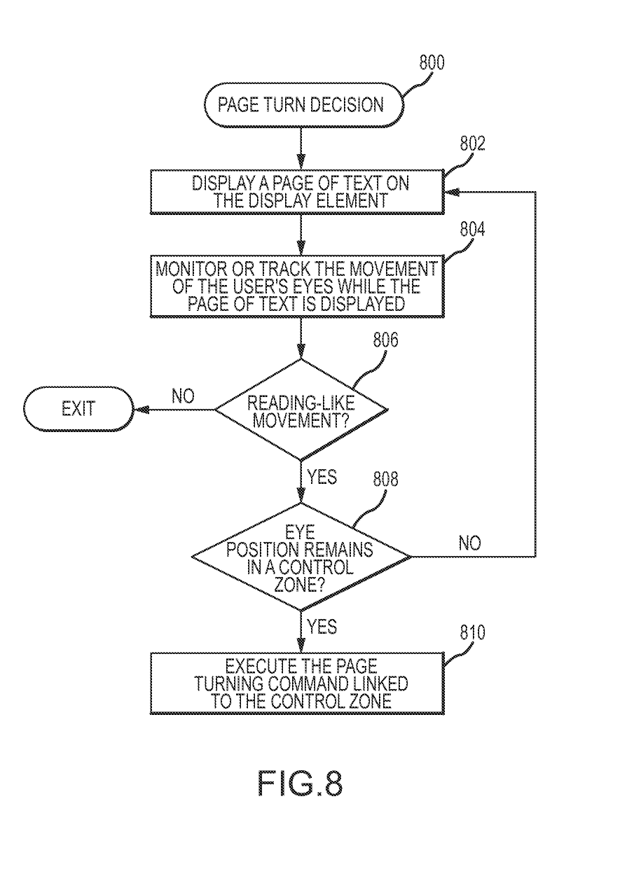

As described above, the automatic page turning feature leverages the captured eye position information to intelligently predict when the reader would like to change the currently displayed page of content. The detected and analyzed conditions that trigger the page turning commands may vary from one device to another, from one operating scenario to another, and in accordance with user/device settings and preferences. In this regard, FIG. 8 is a flow chart that illustrates an embodiment of a page turn decision process 800, which may be performed by an electronic device in connection with the page turning process 700 described above.

The process 800 displays a current page of text on the display element of the device (task 802) and monitors/tracks the movement of the reader's eyes (e.g., iris position and/or pupil position) while the current page is being displayed (task 804). These operations were discussed in detail above, and will not be redundantly described here. Certain embodiments of the process 800 may analyze the eye position data to determine whether or not the reader's eyes are exhibiting a reading-like movement over time (query task 806). If not, then the process 800 may assume that the user is not actually reading the displayed page. In such a scenario, the process 800 may exit or it may return to task 804 to continue monitoring the eye movement pattern of the user.

If query task 806 determines that the user's eye movement pattern is indicative of someone reading a page of text, then the process may check whether the current position of the user's eye (or eyes) have continuously remained within a control zone of the display element for at least a threshold amount of time (query task 808). Different control zones may correspond to different page turning commands, as explained above with reference to FIG. 4. In an effort to reduce unwanted page turning, the process may establish a threshold amount of time that would not usually be detected during normal reading behavior. For example, the threshold time may be set at 200 milliseconds, one-half second, or whatever is deemed appropriate. Moreover, the threshold time could be user-defined in some embodiments. If the process 800 determines that the user's eyes have not dwelled on a control zone for a sufficient amount of time (the “No” branch of query task 808), then the process 800 may exit or return to task 802 to continue monitoring the eye activity for the currently displayed page. If, however, the process 800 determines that the current position of an eye has remained within a control zone for at least the minimum time period (the “Yes” branch of query task 808), then the process 800 may continue by executing the page turning command that corresponds to or is otherwise linked to that particular control zone (task 810).

In certain embodiments, the process 800 may detect when movement of the user's eye (or eyes) is approaching a control zone, either from the perspective of the content orientation or the device orientation. For example, if the process 800 determines that the eyes are moving line-by-line towards the “Page Forward” control zone, then the page can be automatically turned as soon as the eyes reach the control zone. In such an implementation, a “waiting period” need not be utilized, or the threshold period of time may be set to a very short period.

In alternative embodiments, a control zone (such as the “Page Forward” control zone) may be defined to be within a margin space or other area of the display element that is normally void of content. For example, a control zone may be designated as a small area at the lowermost and rightmost corner of the display element, which corresponds to a “white space” or margin of the displayed e-book or text. Consequently, the user may not actually read any text or view any content at or near the control zone. Nonetheless, the process 800 could be designed to detect when the current position of the user's eye (or eyes) has reached the control zone and/or when the current position is within a certain threshold distance from the control zone and, in response to such detection, trigger the desired page turning command.

Moreover, the electronic device could implement one or more backup measures for controlling page turning. For example, the traditional physical buttons and/or touch screen commands of the host device may be preserved. In addition, the electronic device could be suitably configured to initiate page turning commands in response to the detection and analysis of certain gestures, facial expressions, eye movement patterns, sounds, or the like. For instance, a page turning command could be executed when the user blinks his or her eyes while staring at one of the designated control zones. As another example, a page turning command could be executed when the device detects the user's eyes moving in a quick back-and-forth pattern or when the device detects the user's eyes looking past the edge of the display screen. Thus, the onboard camera and various image processing techniques can be leveraged to automatically turn the pages of displayed content without requiring any physical user manipulation of the device.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of controlling page turning operations for content displayed on a display element of an electronic device, the method comprising:
displaying a current page of content on the display element;
capturing, with the electronic device, eye position data that indicates position of an eye of a user of the electronic device;
analyzing the captured eye position data to detect an eye-related condition corresponding to a page turning command; and
executing the page turning command to display a new page of content.

2. The method of claim 1, wherein:
the analyzing is performed to detect an eye-related condition corresponding to a page forward command; and
the new page of content represents a page following the current page of content.

3. The method of claim 1, wherein:
the analyzing is performed to detect an eye-related condition corresponding to a page back command; and
the new page of content represents a page preceding the current page of content.

4. The method of claim 1, wherein the current page of content comprises a page of an electronic book.

5. The method of claim 4, wherein the capturing is performed to track the position of the eye as the user reads the page of the electronic book.

6. The method of claim 1, wherein analyzing the captured eye position data comprises:
determining that a current position of the eye has continuously remained within a control zone of the display element for at least a threshold amount of time.

7. The method of claim 1, wherein analyzing the captured eye position data comprises:
determining that a current position of the eye has reached a control zone of the display element.

8. The method of claim 1, further comprising:
collecting, with the electronic device, light status information, wherein the analyzing and the executing are influenced by the collected light status information.

9. The method of claim 1, further comprising:
collecting, with the electronic device, device orientation information associated with physical orientation of the electronic device, wherein the analyzing and the executing are influenced by the collected device orientation information.

10. The method of claim 1, further comprising:
collecting, with the electronic device, distance information associated with a distance between the eye of the user and the electronic device, wherein the analyzing and the executing are influenced by the collected distance information.

11. The method of claim 1, wherein the capturing is performed by a camera of the electronic device.

12. The method of claim 1, further comprising:
performing a training procedure to calibrate the electronic device for correlation of captured eye position data with areas of the display element.

13. An electronic device comprising:
a processing architecture having at least one processor;
a display element operatively coupled to and controlled by the processing architecture; and
a non-transitory computer readable medium operatively associated with the processing architecture, the computer readable medium comprising executable instructions that, when executed by the processing architecture, cause the processing architecture to perform a method comprising:
displaying a current page of readable text on the display element;
obtaining eye position data that indicates movement of an eye of a user of the electronic device;
analyzing the captured eye position data to detect an eye-related condition corresponding to a page turning command; and
executing the page turning command in response to detecting the eye-related condition.

14. The electronic device of claim 13, wherein the page turning command comprises a command selected from the group consisting of: a page forward command; a page back command; a first page command; a last page command; and a bookmark command.

15. The electronic device of claim 13, wherein analyzing the obtained eye position data comprises:
determining that movement of the eye is approaching a control zone of the display element.

16. The electronic device of claim 13, further comprising a camera configured to capture images of the eye of the user, wherein the obtained eye position data corresponds to the captured images.

17. A method of operating an electronic device having a display element, the method comprising:
determining a physical orientation of the electronic device;
obtaining a distance between the electronic device and an eye of a user of the electronic device;
displaying a current page of content on the display element;
capturing, with a camera of the electronic device, images of the eye of the user during a time when the current page of content is displayed on the display element;
analyzing the images to obtain eye position data, wherein the eye position data correlates position of the eye of the user with areas of the display element;
detecting an eye-related condition corresponding to a page turning command, based on the determined physical orientation of the electronic device, the obtained distance between the electronic device and the eye of the user, and the obtained eye position data.

18. The method of claim 17, wherein detecting the eye-related condition comprises:
determining that a current position of the eye has continuously remained within a control zone of the display element for at least a threshold amount of time.

19. The method of claim 17, further comprising:
collecting, with the electronic device, light status information, wherein the detecting is influenced by the collected light status information.

20. The method of claim 17, further comprising:
performing a training procedure to calibrate the electronic device for correlation of captured eye position data with areas of the display element.
